(19) United States
(12) Patent Application Publication
(10) Pub. No.: US 2020/0198472 A1
(43) Pub. Date: Jun. 25, 2020

(54) SYSTEMS AND METHODS FOR HYBRID ELECTRIC VEHICLE BATTERY STATE OF CHARGE REFERENCE SCHEDULING

(71) Applicant: Cummins Inc., Columbus, IN (US)

(72) Inventors: Richard A. Booth, Columbus, IN (US); Subbarao Varigonda, Columbus, IN (US); Erik L. Piper, Columbus, IN (US)

(73) Assignee: Cummins Inc., Columbus, IN (US)

(21) Appl. No.: 16/609,833

(22) PCT Filed: May 2, 2018
(86) PCT No.: PCT/US2018/030583

§ 371 Date: Oct. 31, 2019

Related U.S. Application Data
(60) Provisional application No. 62/501,353, filed on May 4, 2017.

(51) Int. Cl. B60L 3/12; B60L 15/20; B60L 50/60; B60L 58/13

(52) U.S. Cl. CPC B60L 3/12; B60L 15/2045; B60L 2240/423; B60L 58/13; B60L 50/66

(57) ABSTRACT

A system and method to schedule a state of charge target of an electric vehicle includes a motor, a battery, and a controller communicatively coupled to the motor and the battery. The controller is structured to receive one or more parameters comprising a state of charge of the battery, and adjust the state of charge target based on the one or more parameters.

### CROSS-REFERENCE TO RELATED APPLICATIONS

This application claims the benefit of and priority to U.S. Provisional Application No. 62/501,353, filed May 4, 2017, the content of which is incorporated herein in its entirety.

### TECHNICAL FIELD

The present application relates generally to the field of vehicle battery systems. More particularly, the present application relates to systems and methods for scheduling the state of charge target of a battery of an electric vehicle.

### BACKGROUND

An electric vehicle is a vehicle that uses an electrical motor to move or propel the vehicle. The electric vehicle may be powered solely by battery. Some electric vehicles, such as a hybrid electric vehicle (HEV) or a plug-in hybrid electric vehicle (PHEV) are powered in part by battery. An electric vehicle includes a powertrain system that transmits power to propel the vehicle. In a hybrid electric vehicle that utilizes an internal combustion engine, the powertrain system splits the load between the engine and the battery. In general, hybrid electric vehicles have a static state of charge, while plug-in hybrid electric vehicles have a straight line reduction in the state of charge which results in rapid wear of the battery and inefficient fuel consumption.

Therefore, there exists a need to adjust the state of charge target of an electric vehicle. Having the ability to adjust the state of charge target advantageously provides the ability to increase fuel economy of an electric vehicle by operating the battery and engine and/or generator without a change in the control system.

### SUMMARY

One implementation relates to a powertrain system of an electric vehicle. The powertrain system includes a motor, a battery, and a controller communicatively coupled to the motor and the battery. The controller is structured to: receive one or more parameters comprising a state of charge of the battery, and adjust the state of charge target based on the one or more parameters.

One implementation relates to an apparatus structured to schedule a state of charge of an electric vehicle. The apparatus includes a hybrid controller. The hybrid controller is structured to receive one or more parameters comprising a state of charge of a battery, adjust the state of charge target based on the one or more parameters, and generate a command structured to adjust operation of the battery responsive to the adjustment of the state of charge target.

One implementation relates to a method of scheduling a state of charge of an electric vehicle. The method comprises receiving, via a hybrid controller, one or more parameters comprising a state of charge of a battery, adjusting, via the hybrid controller, the state of charge target based on the one or more parameters, and generating, via the hybrid controller, a command structured to adjust operation of at least one of a motor or a motor-generator unit responsive to the adjustment of the state of charge target.

These and other features of the implementations described herein, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a schematic block diagram of an example vehicle having an example battery according to an example embodiment;

FIG. 2a is a schematic block diagram of a powertrain system included in the vehicle of FIG. 1 according to an example embodiment;

FIG. 2b is a schematic diagram of an example controller that may be used with the systems of FIGS. 1 and 2a;

FIG. 3 is a diagram of a schedule of the state of charge according to some embodiments;

FIG. 4 is a diagram of a state of charge target modification according to some embodiments;

FIG. 5 is a diagram of a state of charge target modification according to some embodiments;

FIG. 6 is a diagram of a state of charge target modification according to some embodiments;

FIG. 7 is a diagram of a state of charge target modification according to some embodiments;

FIG. 8a is a diagram of a state of charge target modification based on a location according to some embodiments;

FIG. 8b is a diagram of a state of charge target modification based on a location according to some embodiments;

FIG. 9a is a diagram of a schedule of the state of charge based on a location according to some embodiments; and

FIG. 9b is a diagram of a schedule of the state of charge based on a location according to some embodiments.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Below is a detailed description of various concepts related to, and implementations of, methods, apparatuses, and systems for scheduling the state of charge of a battery for an electric vehicle. The various concepts introduced above and discussed in greater detail below may be implemented in any of numerous ways, as the described concepts are not limited to any particular manner of implementation. Examples of specific implementations and applications are provided primarily for illustrative purposes.

Referring to the Figures generally, the various embodiments disclosed herein relate to a system and method for scheduling (e.g., moderating) the state of charge of an electric vehicle (e.g., a hybrid electric vehicle, plug-in hybrid electric vehicle, range extender electric vehicle, or other electric vehicle). According to the present disclosure, a controller receives one or more parameters comprising a state of charge of a battery of an electric vehicle, adjusts the state of charge target based on the one or more parameters, and generates a command structured to adjust operation of at least one of a motor, engine, or generator responsive to the adjustment of the state of charge target. Adjustment of the state of charge target extends the life of the battery, improves sociability in the form of less engine noise and emissions at certain times of the day or certain locations, improves the fuel economy and the ability of the battery to accept a charge at a charge station, during a regeneration event, and/or during certain times or at various locations.

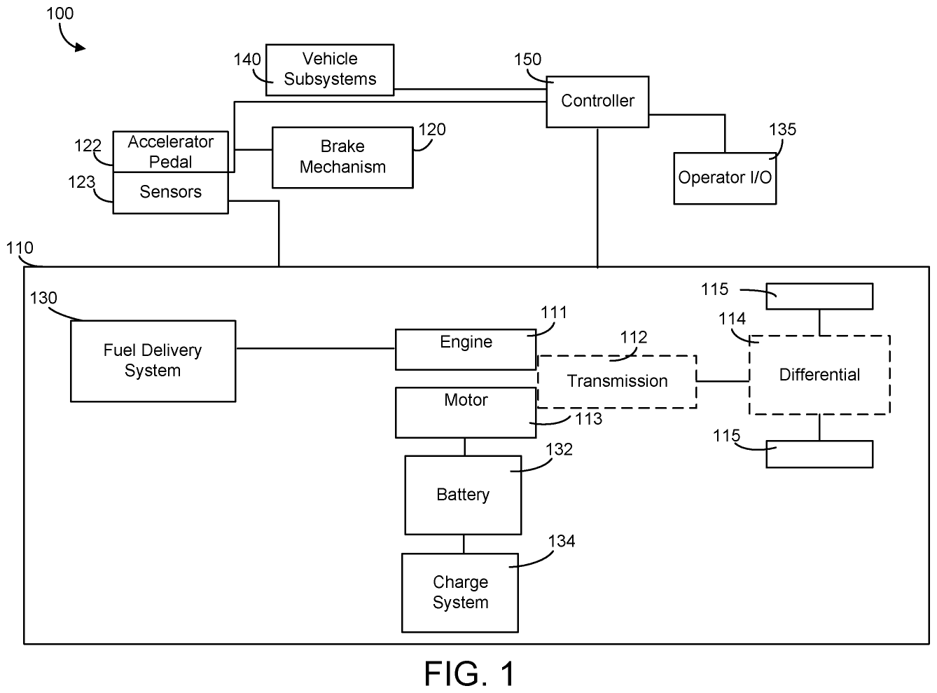

FIG. 1 depicts a schematic block diagram of an example electric vehicle 100 according to an example embodiment. The electric vehicle 100 may be a vehicle, such as a hybrid electric vehicle (HEV), plug-in hybrid electric vehicle (PHEV), range-extended electric vehicle (REEV), extended-range electric vehicle (E-REV), range-extended battery-electric vehicle (BEVx), or other vehicle powered by or otherwise operable via a battery, generator (e.g., a power generator, generator plant, electric power strip, on-board rechargeable electricity storage system, etc.), an engine, a motor (e.g., an electric motor, traction motor, motor-generator unit, etc.), etc. The electric vehicle 100 may be operable in series (e.g., utilizing a single path that powers the wheels of the vehicle and a plurality of energy sources) or in parallel (e.g., utilizing an engine path and an electrical path to power the wheels of the vehicle). The electric vehicle 100 may be an on-road or off-road vehicle including, but not limited to, cars, trucks, trains, ships, boats, vans, airplanes, spacecraft, or any other type of vehicle.

The electric vehicle 100 is shown to generally include a controller 150 communicably and operatively coupled to a brake mechanism 120 (e.g., a brake, braking system, or any other device configured to prevent or reduce motion by slowing or stopping components (e.g., a wheel, axle, pedal, etc. of a vehicle), a powertrain system 110, an operator input/output (I/O) device 135, and one or more additional vehicle subsystems 140. It should be understood that the electric vehicle 100 may include additional, less, and/or different components/systems than depicted in FIG. 1, such that the principles, methods, systems, apparatuses, processes, and the like of the present disclosure are intended to be applicable with any other vehicle configuration. It should also be understood that the principles of the present disclosure should not be interpreted to be limited to on-highway vehicles; rather, the present disclosure contemplates that the principles may also be applied to a variety of other applications including, but not limited to, off-highway construction equipment, mining equipment, marine equipment, locomotive equipment, etc.

The powertrain system 110 facilitates power transfer from the motor 113 and/or the battery 132 to power the electric vehicle 100. In an example embodiment, the vehicle (e.g., a series hybrid electric vehicle) may be operable via a powertrain system 110 which includes a motor 113 operably coupled to a battery 132 and charge system 134, where the motor 113 transfers power to the final drive (shown as wheels 115) to propel the electric vehicle 100. As depicted, the powertrain system 110 includes various components that may be included in a hybrid electric vehicle, such as for example, an engine 111 operably coupled to a transmission 112, a motor 113, and a differential 114, where the differential 114 transfers power output from the engine 111 to the final drive (shown as wheels 115) to propel the electric vehicle 100. As a brief overview and in this configuration, the controller 150 of the electric vehicle 100 (e.g., a hybrid electric vehicle) provides electricity to the motor 113 (e.g., an electric motor) in response to input received by the controller 150 from the accelerator pedal 122, charge system 134 (e.g., a battery charging system, rechargeable battery, etc.), etc. The battery 132 may be structured to receive a rapid charge. In some embodiments, the electricity provided to power the motor 113 may be provided by an onboard gasoline-engine generator, a hydrogen fuel cell, etc.

In some embodiments, the electric vehicle 100 may also include the engine 111 which may be structured as an internal combustion engine that receives a chemical energy input (e.g., a fuel such as natural gas, gasoline, ethanol, or diesel) from the fuel delivery system 130, and combusts the fuel to generate mechanical energy, in the form of a rotating crankshaft. The transmission 112 receives the rotating crankshaft and manipulates the speed of the crankshaft (e.g., the engine speed, which is usually expressed in revolutions-per-minute (RPM)) to effect a desired drive shaft speed. A rotating drive shaft may be received by a differential 114, which provides the rotation energy from the drive shaft to the final drive 115. The final drive 115 then propels or moves the electric vehicle 100. Further, the drive shaft may be structured as a one-piece, two-piece, and/or a slip-in-tube driveshaft based on the application.

In some examples, the electric vehicle 100 may include the transmission 112. The transmission 112 may be structured as any type of transmission, such as a continuous variable transmission, a manual transmission, an automatic transmission, an automatic-manual transmission, a dual clutch transmission, etc. Accordingly, as transmissions vary from geared to continuous configurations (e.g., continuous variable transmission), the transmission can include a variety of settings (e.g., gears, for a geared transmission) that affect different output speeds based on the engine speed. Like the engine 111, the transmission 112, motor 113, differential 114, and final drive 115 may be structured in any configuration dependent on the application (e.g., the final drive 115 may be structured as wheels in an automotive application and a propeller in an airplane application).

The electric vehicle 100 may include a throttle system (e.g., a throttle system including an intake manifold throttle) depending on the engine system utilized. The throttle system generally includes a throttle valve (e.g., a ball valve, a butterfly valve, a globe valve, or a plug valve), which in certain embodiments is operatively and communicably coupled to an accelerator pedal 122 and/or one or more sensors 123. The throttle valve is structured to selectively control the amount of intake air provided to the engine 111. Because the type of engine 111 may vary from application-to-application, the type of throttle valve may also vary with all such possibilities and configurations falling within the spirit and scope of the present disclosure. The term “throttle system” as used herein should be understood broadly, and may refer to any air management system, including without limitation an intake throttle, an exhaust throttle, and/or manipulations of an air handling device such as a turbocharger (e.g. a wastegate turbocharger and/or a variable geometry turbocharger). The throttle system may additionally or alternatively be active during stoichiometric-like operations of the engine, and inactive or less active during lean burn-like operations of the engine.

The accelerator pedal 122 may be structured as any type of torque and/or speed request device included with a system (e.g., a floor-based pedal, an acceleration lever, etc.). Further, the sensors 123 may include any type of sensors included with the brake mechanism 120, accelerator pedal 122, or any other component and/or system included in the powertrain system 110 of a vehicle. For example, the sensors 123 may include a fuel temperature sensor, a charge air temperature sensor, a coolant temperature and pressure sensor, an ambient air temperature and pressure sensor, a fuel pressure sensor, an injection pump speed sensor, and the like.

As depicted, the electric vehicle 100 includes the operator I/O device 135. The operator I/O device 135 enables an operator of the vehicle to communicate with the electric vehicle 100 and the controller 150. Analogously, the I/O device 135 enables the vehicle or controller 150 to communicate with the operator. For example, the operator I/O device 135 may include, but is not limited, an interactive display (e.g., a touchscreen, etc.) having one or more buttons/input devices, haptic feedback devices, an accelerator pedal, a brake pedal, a shifter for the transmission, a cruise control input setting, a navigation input setting, etc. Via the I/O device 135, the controller 150 can also provide commands/instructions/information to the operator (or a passenger).

As also shown, the electric vehicle 100 includes one or more vehicle subsystems 140. The various vehicle subsystems 140 may generally include one or more sensors (e.g., a speed sensor, torque sensor, ambient pressure sensor, temperature sensor, etc.), as well as any subsystem that may be included with a vehicle. Accordingly, in an embodiment including a hybrid electric vehicle, the subsystems 140 may also include an exhaust aftertreatment system structured to reduce diesel exhaust emissions, such as a selective catalytic reduction catalyst, a diesel oxidation catalyst (DOC), a diesel particulate filter (DPF), a diesel exhaust fluid doser with a supply of diesel exhaust fluid, and a plurality of sensors for monitoring the exhaust aftertreatment system (e.g., a NOx sensor).

The controller 150 is communicably and operatively coupled to the powertrain system 110, brake mechanism 120, accelerator pedal 122, the operator I/O device 135, and the one or more vehicle subsystems 140. Communication between and among the components may be via any number of wired or wireless connections (e.g., any standard under IEEE 802, etc.). For example, a wired connection may include a serial cable, a fiber optic cable, an SAE J1939 bus, a CAT5 cable, or any other form of wired connection. In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information, and/or data. Because the controller 150 is communicably coupled to the systems and components in the electric vehicle 100 of FIG. 1, the controller 150 is structured to receive data (e.g., instructions, commands, signals, values, etc.) from one or more of the components shown in FIG. 1.

It should also be understood that other or additional operating parameters to schedule the state of charge of the battery may be used. For example, the operating parameters may include the time of day, time of operation relative to daily mission, location data, route schedule data structured to indicate the upcoming grade, vehicle grade sensor data, ridership data, vehicle weight, ambient conditions, state of health of the battery, or any other suitable parameter internal and/or external to the electric vehicle 100.

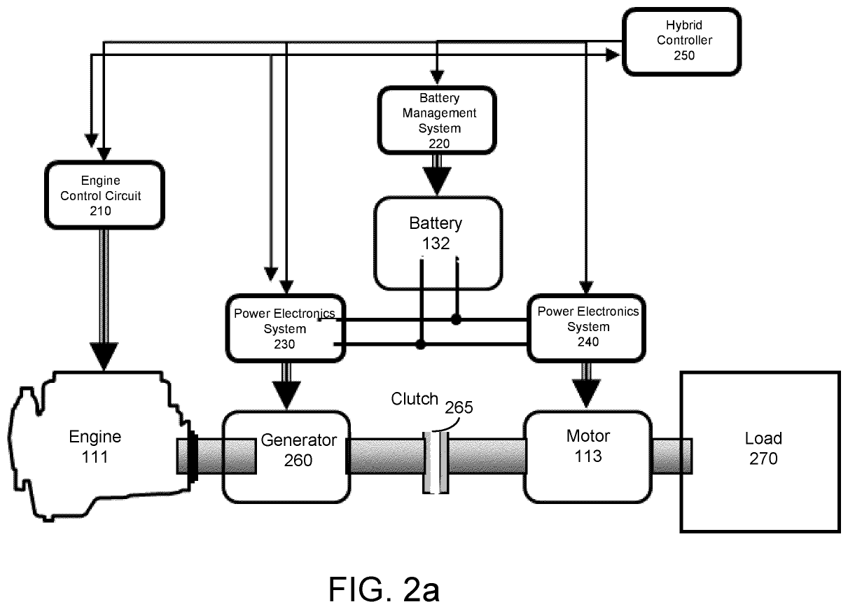

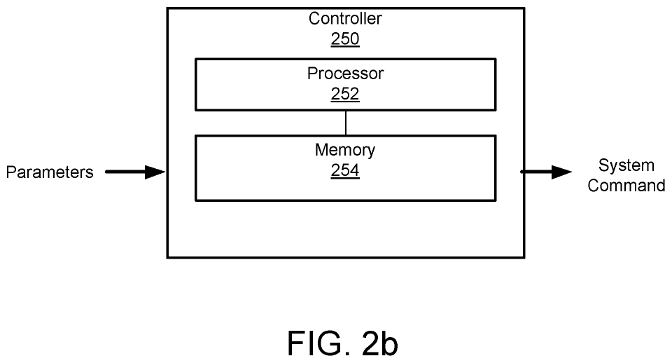

The controller 150 is communicatively coupled to or may take the form of, for example, a hybrid controller 250 as described herein with reference to FIG. 2a. The hybrid controller 250 may be communicatively coupled to, or included within, the powertrain system 110. As shown in FIG. 2b, the hybrid controller 250 may include a processor 252 such as, but not limited to, a microprocessor, programmable logic controller (PLC) chip, an ASIC chip, or any other suitable processor. The processor 252 which is in communication with the memory 254 is structured to execute instructions, algorithms, commands or otherwise programs stored in the memory. The memory 254 includes any of the memory and/or storage components discussed herein. For example, the memory 254 may include RAM and/or cache of the processor. The memory 254 may also include one or more storage devices (e.g., hard drives, flash drives, computer readable media, etc.) either local or remote to the hybrid controller 250. The memory is structured to store look up tables, algorithms, or instructions. Further, as the components of FIG. 1 are shown to be embodied in an electric vehicle 100, the hybrid controller 250 may be structured as, include, or be communicably and operatively coupled to at least one of a power electronics system, motor controller, powertrain system controller, engine control circuit, battery management system, etc. The function and structure of the controller is described herein with reference to FIG. 2a.

FIG. 2a is a schematic block diagram of a powertrain system 110 included in a vehicle (e.g., the electric vehicle 100) according to an example embodiment. In the present embodiment, the powertrain system 110 includes a battery management system 220, battery 132, power electronics systems 230, 240, engine control circuit 210, engine 111, hybrid controller 250, generator 260, motor 113, clutch 265, and load 270. It should be understood that the powertrain system 110 of FIG. 2a depicts only one embodiment of the powertrain system 110 and any other powertrain system capable of performing the operations described herein can be used.

The powertrain system 110 may include the engine control circuit 210 (e.g., an engine control unit, controller, etc.). The engine control circuit 210 is structured to control the engine 111 and/or the generator 206. In some embodiments, the engine control circuit 210 may be communicatively coupled to the power electronics system 230 such that the engine control circuit 210 and the power electronics system 230 may control the engine 111 and the generator 206. The engine control circuit 210 and the power electronics system 230 may provide data to and/or receive commands from the hybrid controller 250 regarding how much power (e.g., the power amount) may be requested from the engine 111 and the generator 206 to supplement the battery 132. In some embodiments, the power electronics system 240 may be structured to control the motor 113. The power electronics system 240 may receive commands from the hybrid controller 250 regarding the amount of torque or power that may be required at the wheels via the motor 113.

The powertrain system 110 may include the battery management system 220. The battery management system 220 may be structured to control, monitor, or otherwise manage the battery 132. The battery management system 220 maintains a state of charge (SOC) value, a state of health value (SOH), or a combination thereof. For example, the battery management system 220 may maintain values indicating the state of charge and state of health of the battery 132. The values indicating the state of charge and the state of health may be stored in or otherwise accessed via the memory 254. As used herein, the term “state of health value” may represent the total percent of the total life of the battery that has not been consumed to date. For example, a new battery may have a 100% state of health and a used battery that must be replaced may have a 0% state of health.

The powertrain system 110 may include the hybrid controller 250. The hybrid controller 250 may be structured to receive one or more operating parameters associated with the state of charge and/or the state of health of the battery 132. The operating parameters may be received from various components, circuits, controllers, systems, etc. that may be internal and/or external to the powertrain system 110 and/or the electric vehicle 100. The operating parameters may include location data, the time of day, time of operation relative to a daily mission, route schedule data structured to indicate an upcoming grade, vehicle grade sensor data, ridership data, vehicle weight, ambient conditions, state of health of the battery 132, state of charge of the battery 132, or a combination thereof. The hybrid controller 250 may monitor the battery 132 of the electric vehicle 100 via the battery management system 220. In turn, the hybrid controller 250 may be structured to adjust the state of charge target based on the one or more received parameters.

The hybrid controller 250 may be structured to determine one or more power amounts (e.g., a power amount, torque amount, or combination thereof) based on the one or more parameters as described herein. For example, the hybrid controller 250 may determine the power amount and the torque amount based on the state of charge of the battery 132. Alternatively or additionally, the hybrid controller 250 may determine the power amount and the torque amount based on the state of health of the battery 132. As used herein, the term “power amount” may be used to indicate the desired electrical power and/or engine speed to be generated by the engine 111 and/or the generator 206. The power amount may indicate how much energy is to be provided to the motor (e.g., a traction motor) from the battery 132 relative to the amount of energy to be provided by the engine 111 and the generator 206. Responsive to the receipt of the one or more parameters, the hybrid controller 250 may provide the power amount to the engine 111 and/or the generator 206.

In some embodiments, the hybrid controller 250 may be structured to generate a command (e.g., a code). The command may be structured to adjust operation of at least one of the motor 113, engine 111, or generator 206 responsive to the adjustment of the state of charge target. To that end, the hybrid controller 250 may be structured to generate a command for provision to the engine control circuit 210 and/or the power electronics systems 230. In further embodiments, the command may be structured to indicate the torque amount required at the wheels via the motor 113. In further examples, the hybrid controller 250 may be structured to generate a command to the engine control circuit 210 and/or the power electronics systems 230 structured to indicate the power amount requested from the engine 111 and generator 206 to supplement the battery 132. The command is further structured to cause the motor 113 to operate according to the power amount determined.

In some examples, the required power amount may be divided or otherwise split between the motor 113, the engine 111, and/or the generator 206 such that the motor 113, the engine 111, and/or the generator 206 may operate at the same or different time. Based on the state of charge target adjustment (e.g., upward, downward, increased, or decreased), the load 270 may be weighted more heavily towards the engine 111 as compared to the battery 132 as the system maintains a higher actual state of charge. For example, the power amount requested from the engine 111 may be more than the power amount or energy requested from the battery 132 and/or the torque amount requested from the motor 113. If the state of charge target is adjusted (e.g., downward, upward, increased, or decreased), the load 270 may be weighted more heavily towards the battery 132 as compared to the engine 111 as the system moves toward a lower actual state of charge. For example, the power amount requested from the engine 111 may be less than the energy or power amount requested from the battery 132 and/or the torque amount requested from the motor 113.

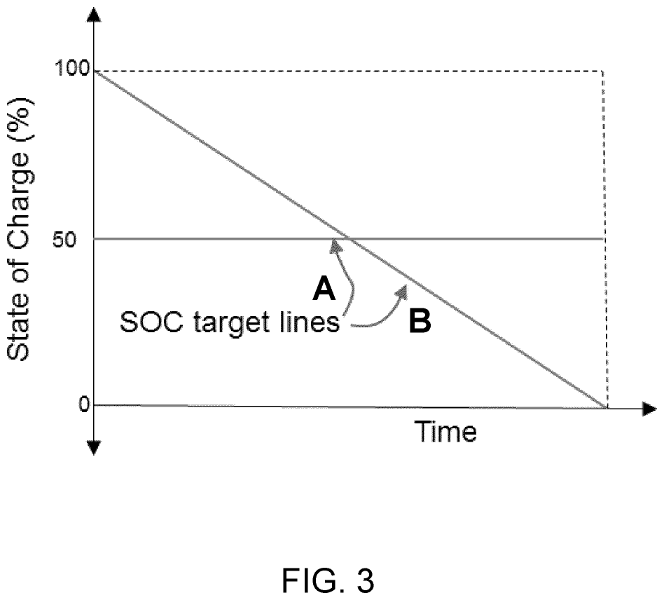

Alternatively or additionally, the command may be further structured to cause a charge event responsive to the adjustment of the state of charge as described herein with reference for FIGS. 3-9b. In some embodiments, the hybrid controller 250 may be structured to generate a plurality of commands. In this regard, the command communicates the power amount and/or the torque amount to the power electronics systems 230, 240 to actuate various components, circuits, or levers of the powertrain system 110 to cause the adjustment of the operation of at least one of the motor 113, engine 111, or generator 206.

FIGS. 3-9b illustrate the scheduling of the state of charge (SOC) according to various embodiments. In FIG. 3, two state of charge target lines A, B are illustrated. The state of charge target line A represents a state of charge of a traditional hybrid electric vehicle which typically uses the battery and motor to improve efficiency. Each duty cycle (e.g., each drive cycle, drive day, etc.) is completed with at or near the same amount of charge remaining on the battery. The state of charge target line B represents a decreasing state of charge target line of a plug-in hybrid vehicle. The battery starts each duty cycle with a fully charged battery (e.g., at 100% state of charge). In order to optimize the fuel economy, the plug-in hybrid vehicle is brought back with the battery state of charge at or near 0%.

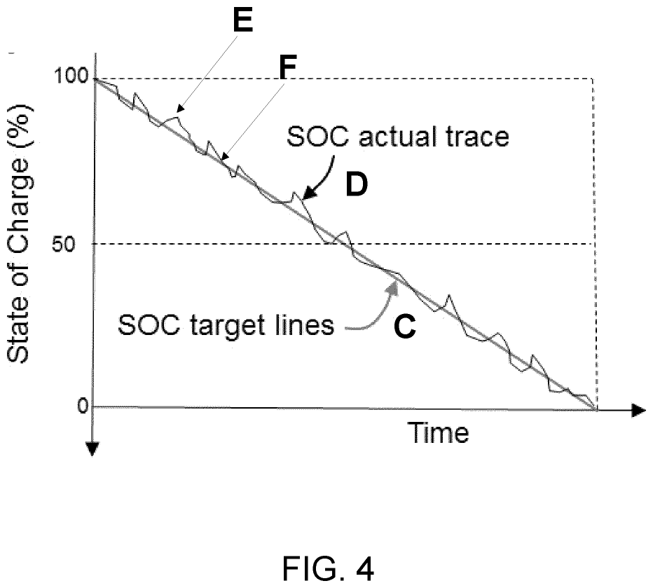

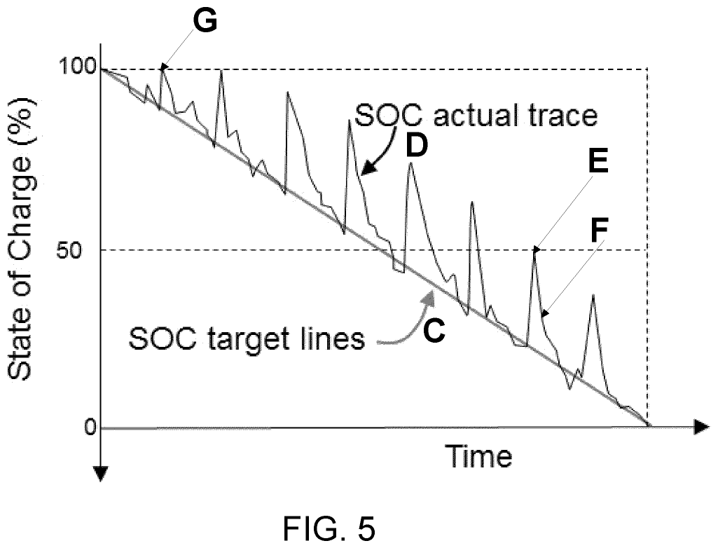

FIGS. 4-5 illustrate a state of charge target modification according to some embodiments. In this example, the state of charge target line C may decline linearly throughout the day. The actual state of charge line D represents a trace of the actual state of charge throughout the day. As depicted, the state of charge target line C and the actual state of charge line D show typical behavior of an electric vehicle (e.g., a plug-in hybrid vehicle) that does not undergo a charge event during the day. The peaks E may be generated when the electric vehicle drives downhill or in response to a braking event. The downward sloping portions F represent usage of the battery energy to supplement the use of the engine and/or the generator to provide current to the motor. As shown, the battery energy is used in a fairly uniform manner across the duty cycle during the full day.

FIG. 5 illustrates the state of charge of a battery included in the electric vehicle that has charge events throughout the day. The actual state of charge line D shows a normal charge depletion with charge events that occur periodically during the day. Responsive to a charge event, the actual state of charge line D demonstrates a significant increase (e.g., a spike) of the use of the total charge capacity (e.g., a charge capacity of 100%) of the battery. After the charge event, the battery energy expended significantly increases due to the difference between the state of charge target line C and the actual state of charge line D. The charge events early in the day are impeded or otherwise reduced by the capacity charge line G which indicates the total charge capacity. This results in a limitation of the total benefit of the charge events and limits total fuel economy optimization.

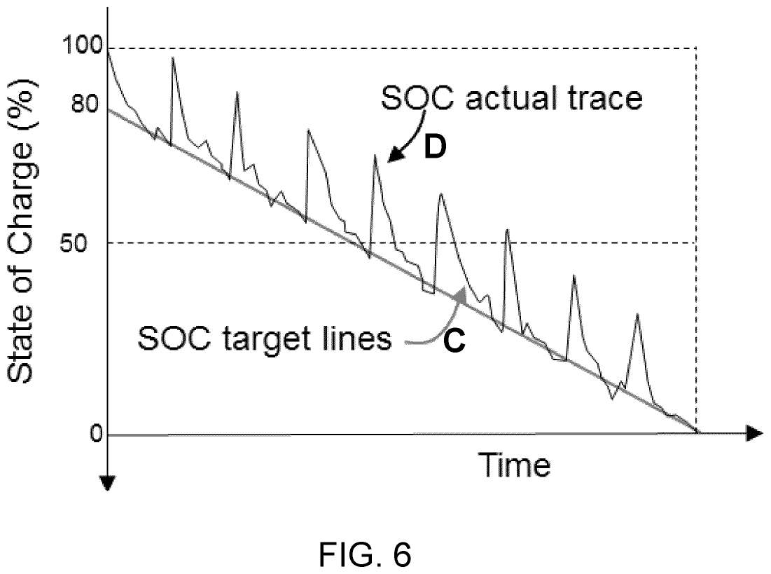

FIG. 6 illustrates a state of charge modification according to some embodiments. As depicted, the state of charge target line C has been adjusted or otherwise modified to start at an 80% state of charge which results in a rapid decrease in the actual state of charge at the start of the duty cycle. In such examples, the battery may be utilized instead of the engine. For example, the battery may be utilized and the engine may be utilized significantly less than the battery is utilized which facilitates or otherwise causes the battery to deplete or otherwise discharge rapidly. Alternatively or additionally, the battery may receive a charge after a reduced period (e.g., receive a quick charge after 2 hours) of operation. The reduced period to charge the battery may be the result of the adjusted difference between the state of charge target line C and the actual state of charge. In some embodiments, the battery management system may manage the depletion of the battery based on a predetermined limit such that the battery management system may limit the depletion of the battery. Advantageously the adjustment of the state of charge target generates a higher fuel savings due to the ability to recharge the battery according to a reduced period in contrast to the examples depicted in FIGS. 3-5.

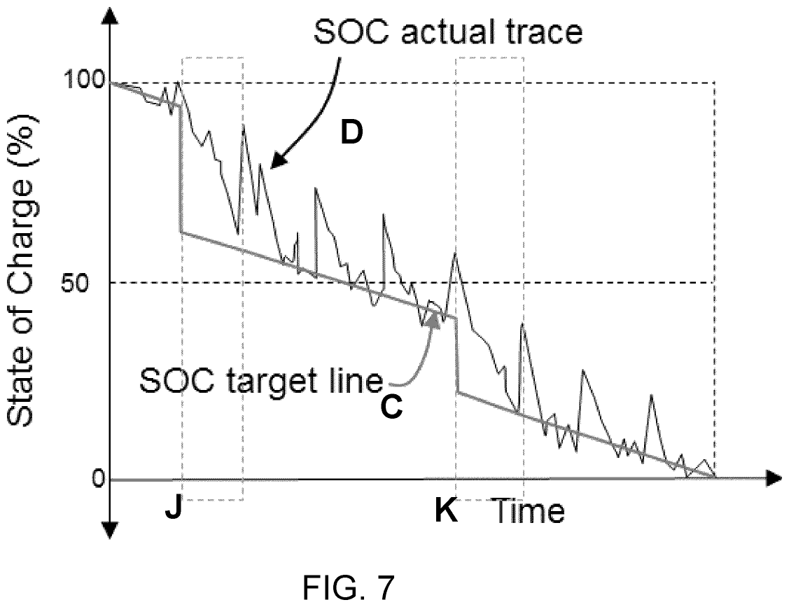

FIG. 7 illustrates a state of charge target modification according to a predetermined time period. In the example illustrated, the battery may be used during peak ridership in the morning and the afternoon rush hours. As depicted, the state of charge demonstrates a slower charge depletion over time throughout the day with a rapid change (e.g., a rapid reduction) in the state of charge target before the battery usage is increased significantly or otherwise during low engine periods. In turn, the vehicle does not take advantage of the periodic charge event early in the day. When the first rush hour period starts at J, the state of charge target line C is adjusted (e.g., moved downward) which results in increasing the battery usage as the hybrid controller and/or the battery management system generates a command structured to adjust the operation of the motor (e.g., increase the use of the motor) to move the actual state of charge down to the state of charge target.

When the actual state of charge line D reaches the state of charge target line C, a power plant or other power resource may use the engine and generator to follow the state of charge target line C. Because of the high expenditure of energy during, for example, the first rush hour period J, the battery is structured to absorb as much energy as is made available during a charge event (e.g., a rapid charge event). At the second rush hour period K, the state of charge target line C is adjusted (e.g., moved further downward) which results in increasing the battery usage as the power plant or other power resource spends energy to adjust, approach, or otherwise meet the state of charge target line C.

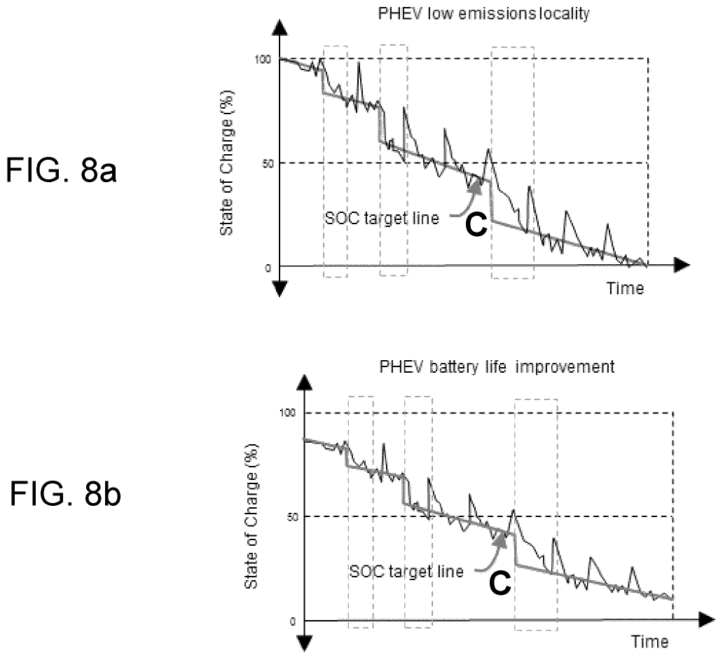

FIGS. 8a-8b depict a state of charge target modification based on a location. For example, the location may be a low emission locality, district, zone, area, etc. As described above with reference to FIG. 7, the state of charge target line C may be adjusted (e.g., moved downward) when the vehicle approaches or otherwise enters or arrives at a location which may be indicated, via global position system (GPS) data, route programming, location beacon, etc., as a low emission district. The amount of the state of charge target adjusted may be proportional to the duration of time the vehicle is at or in the location. Alternatively or additionally, the state of charge target may be moderated by the total amount of energy available in the battery such that the state of charge target may be calibrated according to the duty cycle. FIG. 8b depicts a state of charge target modification structured to respond to excess battery wear. In this example, the state of charge target includes a lower limit and/or an upper limit that may be modified to operate in a targeted range (e.g., a smaller range) such that the battery wear is reduced.

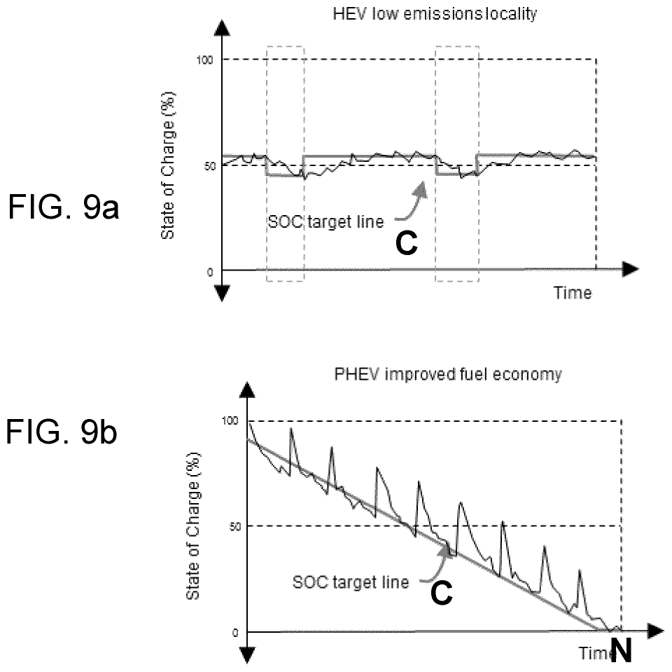

FIGS. 9a-9b illustrates a state of charge target modification based on a location. Upon entering a location such as, but not limited to, a low emission district, the state of charge target line C may be adjusted (e.g., moved downward) which results in less engine operation for a period of time. After the location is exited, the state of charge target line C may be adjusted (e.g., moved upward, restored, etc.) to a previous level. In some examples, the state of charge target may be calibrated according a predetermined time period in examples wherein the duration of the low emissions operation may be predetermined.

As illustrated in FIG. 9b, there may be examples that require the state of charge to be depleted or discharged fully. In such examples, the state of charge target may be calibrated to reach a minimum charge before the end N of a duty cycle (e.g., before the end of a route, drive cycle, drive day, etc.). In further examples, the state of charge target may be adjusted (e.g., lowered) from a total charge capacity (e.g., a charge capacity of 100%) to drive more energy out of the battery early in the duty cycle and to ensure that regeneration and charge events may be received.

The schematic diagrams described above are generally set forth as logical flow chart diagrams. As such, the depicted order and labeled steps are indicative of representative embodiments. Other steps, orderings and methods may be conceived that are equivalent in function, logic, or effect to one or more steps, or portions thereof, of the methods illustrated in the schematic diagrams.

Additionally, the format and symbols employed are provided to explain the logical steps of the schematic diagrams and are understood not to limit the scope of the methods illustrated by the diagrams. Although various arrow types and line types may be employed in the schematic diagrams, they are understood not to limit the scope of the corresponding methods. Indeed, some arrows or other connectors may be used to indicate only the logical flow of a method. For instance, an arrow may indicate a waiting or monitoring period of unspecified duration between enumerated steps of a depicted method. Additionally, the order in which a particular method occurs may or may not strictly adhere to the order of the corresponding steps shown. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Many of the functional units described in this specification have been labeled as circuits, in order to more particularly emphasize their implementation independence. For example, a circuit may be implemented as a hardware circuit comprising custom VLSI circuits or gate arrays, off-the-shelf semiconductors such as logic chips, transistors, or other discrete components. A circuit may also be implemented in programmable hardware devices such as field programmable gate arrays, programmable array logic, programmable logic devices or the like.

Circuits may also be implemented in machine-readable medium for execution by various types of processors. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit.

Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network. Where a circuit or portions of a circuit are implemented in machine-readable medium (or computer-readable medium), the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope. No claim element herein is to be construed under the provisions of 35 U.S.C. § 112, sixth paragraph, unless the element is expressly recited using the phrase “means for.”

What is claimed is:

1. A powertrain system of an electric vehicle, comprising:
a motor;
a battery; and
a controller communicatively coupled to the motor and the battery, the controller structured to:
receive one or more parameters indicative of a state of charge of the battery; and
adjust a state of charge target based on the one or more parameters.

2. The system of claim 1, wherein the electric vehicle comprises a hybrid electric vehicle, plug-in hybrid electric vehicle, or range extender electric vehicle.

3. The system of claim 1, wherein the controller is further structured to generate a command, the command structured to adjust operation of at least one of the motor, the battery, an engine, or a motor-generator unit responsive to the adjustment of the state of charge target.

4. The system of claim 3, wherein the command is further structured to cause the motor to operate according to a determined torque amount, and wherein the command is further structured to cause the engine to operate according to a determined power amount.

5. The system of claim 1, wherein the battery is further structured to charge responsive to the adjustment of the state of charge target.

6. The system of claim 1, wherein the battery is further structured to deplete energy responsive to the adjustment of the state of charge target.

7. The system of claim 1, wherein the controller is further structured to maintain a state of charge value, a state of health value, or a combination thereof.

8. The system of claim 1, wherein the one or more operating parameters comprises a time of day, time of operation relative to daily mission, route schedule data, vehicle grade sensor data, ridership data, vehicle weight, ambient conditions, state of health of the battery, or a combination thereof.

9. An apparatus structured to schedule a state of charge of an electric vehicle, the apparatus comprising:
a hybrid controller structured to:
receive one or more parameters indicative of a state of charge of a battery;
adjust a state of charge target based on the one or more parameters; and
generate a command structured to adjust operation of the battery responsive to the adjustment of the state of charge target.

10. The apparatus of claim 9, wherein the command is further structured to adjust operation of at least one of an engine, motor, or a motor-generator unit.

11. The apparatus of claim 9, wherein operation of a powertrain system of the electric vehicle is adjusted to meet the state of charge target.

12. The apparatus of claim 9, wherein the state of charge target is adjusted based on a location, and wherein the location comprises a low emission district, locality, zone, or area.

13. The apparatus of claim 9, wherein the battery is further structured to charge responsive to the adjustment of the state of charge target.

14. The apparatus of claim 9, wherein the battery is further structured to deplete energy responsive to the adjustment of the state of charge target.

15. A method of scheduling a state of charge target of an electric vehicle, the method comprising:
receiving, via a hybrid controller, one or more parameters indicative of a state of charge of a battery;
adjusting, via the hybrid controller, a state of charge target based on the one or more parameters; and
generating, via the hybrid controller, a command structured to adjust operation of at least one of a motor or a motor-generator unit responsive to the adjustment of the state of charge target.

16. The method of claim 15, further comprising determining a power amount or a torque amount required at one or more wheels of the electric vehicle.

17. The method of claim 16, wherein the command is further structured to cause the motor to operate according to the determined torque amount.

18. The method of claim 16, wherein the command is further structured to cause an engine, the motor-generator, or a combination thereof to operate according to the determined power amount.

19. The method of claim 15, wherein the command is further structured to cause a charge event responsive to the adjustment of the state of charge target.

20. The method of claim 15, further comprising monitoring the battery of the vehicle.

21. The method of claim 15, wherein the battery is structured to receive a rapid charge responsive to the adjustment of the state of charge target.

22. The method of claim 15, wherein the battery is further structured to deplete energy responsive to the adjustment of the state of charge target.

23. The method of claim 15, wherein the state of charge target is adjusted based on a location, and wherein the location comprises a low emission district, locality, zone, or area.
